(19) United States
(12) Patent Application Publication
(10) Pub. No.: US 2018/0230759 A1
(43) Pub. Date: Aug. 16, 2018

(54) SHOCK MITIGATION DEVICES

(71) Applicant: SHELL OIL COMPANY, HOUSTON, TX (US)

(72) Inventor: Robert Thomas BROOKS, Sparks, NV (US)

(21) Appl. No.: 15/765,582

(22) PCT Filed: Oct. 5, 2016
(86) PCT No.: PCT/US2016/055401

§ 371 Date: Apr. 3, 2018

Related U.S. Application Data
(60) Provisional application No. 62/238,802, filed on Oct. 8, 2015.

(51) Int. Cl. E21B 17/07; F16L 55/04

(52) U.S. Cl. CPC E21B 17/07; E21B 29/02; F16L 55/04

(57) ABSTRACT

A shock mitigation device (100) comprising: a first end (130), a second end (140), and an inner tubular (150), wherein the inner tubular defines an internal cavity (110). In certain embodiments the present disclosure relates to shock mitigation devices connected to a riser for use with emergency separation tools using explosive charges to sever a workstring at a location above a blowout preventer stack in a well.

### CROSS REFERENCE TO RELATED APPLICATIONS

This application claims the benefit of U.S. Provisional Application No. 62/238,802, filed Oct. 8, 2015, which is incorporated herein by reference.

### BACKGROUND

The present disclosure relates generally to shock mitigation devices. More specifically, in certain embodiments the present disclosure relates to shock mitigation devices for use with emergency separation tools and associated methods and systems.

In emergency situations it is often desirable to be able to sever a tubular in a wellbore. Particularly it is often desirable to sever a workstring at a location above the blowout preventer stack such that the lower part of the workstring can drop down below the blowout preventer stack allowing the blowout preventer to close more effectively than if the workstring was in the path of the blowout preventer rams, and secure the well.

Several U.S. patents describe the use of an explosive charge to sever a work string. Examples include U.S. Pat. Nos. 5,253,585, 7,779,760, 5,251,702, and 9,097,080, the entireties of which are hereby incorporated by reference. Other improved methods of using explosive charges are described in U.S. Patent Application Publication Nos. 2013/0220631, 2013/0214183, and 2014/0224500, the entireties of which are hereby incorporated by reference.

When using the discussed above devices, shock waves may be created that propagate up through the steel housing and riser components as well as through the fluids present in the riser. When shock waves travel through steel components they may cause the joints between components to stretch and leak. Studs that lock flanges together may be permanently deformed by the shock loading and, in extreme cases, may allow fluid to escape into the surrounding environment. Shock waves traveling through the steel components may also cause the components to “ring” and the attenuation of the shockwaves can destroy/interrupt the electrical components/electronic signals that control the operation of the blowout stack preventers.

Shockwaves are also capable of travelling through surrounding fluids to the areas where the blowout preventer stack control pods are located. A significant pressure wave could damage/destroy sensitive and critical control valves and electronics that are necessary for operation of the blowout preventers. Furthermore, a shockwave may be created in the internal bore of the severance device as it severs the tubular is transmitted through the fluids contained therein, both upwards and downwards. This pressure wave, if large enough, may travel up the inside of the marine riser to the rig floor causing an unconstrained release of well fluids. Additionally, the release of the shockwave downwards could impact a sensitive subterranean formation causing irreparable damage and possible formation collapse.

It is desirable to develop a device that is capable of mitigating the effects of shock waves traveling generated by the use of high explosive charges.

### SUMMARY

The present disclosure relates generally to shock mitigation devices. More specifically, in certain embodiments the present disclosure relates to shock mitigation devices for use with emergency separation tools and associated methods and systems.

In one embodiment, the present disclosure provides a shock mitigation device comprising: a first end, a second end, and an inner tubular, wherein the inner tubular defines an internal cavity.

In another embodiment, the present disclosure provides a shock mitigation system comprising: a riser and a shock mitigation device attached to the riser, wherein the shock mitigation device comprises a first end, a second end, and an inner tubular, wherein the inner tubular defines an internal cavity.

In another embodiment, the present disclosure provides a method of mitigating a shock comprising: providing a shock mitigation system, wherein the shock mitigation system comprises a riser, a drill pipe disposed within the riser, an emergency separation tool disposed around the drill pipe, and a shock mitigation device attached to the riser, wherein the shock mitigation device comprises a first end, a second end, and an inner tubular, wherein the inner tubular defines an internal cavity and severing the drill pipe with the emergency separation tool.

### BRIEF DESCRIPTION OF THE DRAWINGS

A more complete and thorough understanding of the present embodiments and advantages thereof may be acquired by referring to the following description taken in conjunction with the accompanying drawings.

FIG. 1 is an illustration of a shock mitigation device in accordance with certain embodiments of the present disclosure.

FIG. 2 is an illustration of a shock mitigation device in accordance with certain embodiments of the present disclosure.

FIG. 3 is an illustration of a shock mitigation device in accordance with certain embodiments of the present disclosure.

FIG. 4 is an illustration of a shock mitigation system in accordance with certain embodiments of the present disclosure.

FIG. 5 is an illustration of a shock mitigation system in accordance with certain embodiments of the present disclosure.

The features and advantages of the present disclosure will be readily apparent to those skilled in the art. While numerous changes may be made by those skilled in the art, such changes are within the spirit of the disclosure.

### DETAILED DESCRIPTION

The present disclosure relates generally to shock mitigation devices. More specifically, in certain embodiments the present disclosure relates to shock mitigation devices for use with emergency separation tools and associated methods and systems.

One potential advantages of the shock mitigation devices discussed herein is that their use may reduce and/or mitigate the effect of the shockwaves in steel riser components and within the riser fluid. The mitigation and/or reduction of this effect can reduce the effects of collateral damage to the overall system and may also stop a fluid/gas bubble from being released to the surface.

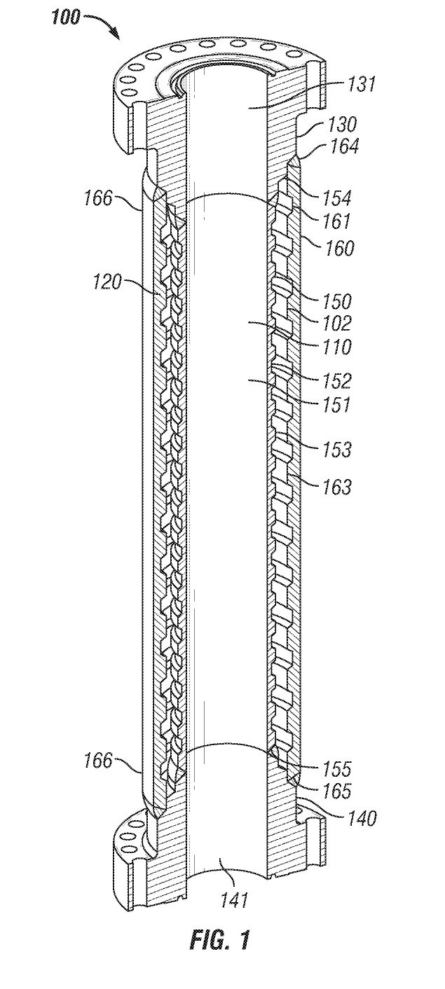

Referring now to FIG. 1, FIG. 1 illustrates a shock mitigation device 100. In certain embodiments, shock mitigation device 100 may comprise a joint of a riser or may be connected to one or more sections of a riser. In certain embodiments, shock mitigation device 100 may be a tubular device defining an internal cavity 110 and an internal annulus 120. In certain embodiments, shock mitigation device may be constructed out of any material that matches the pressure and load/structural capabilities of the equipment it is mated to.

In certain embodiments, shock mitigation device 100 may comprise a first end 130, a second end 140, an inner tubular 150, and an outer tubular 160.

In certain embodiments, inner tubular 150 may be a tubular wall constructed of low alloy carbon steel. In certain embodiments, inner tubular 150 may be a solid tubular wall with no perforations. In certain embodiments, inner tubular 150 may have a length in the range of from 5 feet to 20 feet. In certain embodiments, inner tubular 150 may have a thickness in the range of from 1 inch to 2 inches. In certain embodiments, inner tubular 150 may be welded at a first end 154 to first end 130. In certain embodiments, inner tubular 150 may be welded at a second end 155 to second end 140.

In certain embodiments, inner tubular 150 may have an inner diameter in the range of from 10 inches to 25 inches. In certain embodiments, inner tubular 150 may have an inner diameter that matches the inner diameter of any blowout preventer on which shock mitigation device 100 is mounted. In certain embodiments, inner tubular 150 may have an inner diameter of 18.75 inches. In certain embodiments, inner tubular 150 may define internal cavity 110.

In certain embodiments, inner tubular 150 may comprise an inner surface 151 and an outer surface 152. In certain embodiments, inner surface 151 may be a smooth surface. In certain embodiments, outer surface 152 may comprise a plurality of castellations 153. In certain embodiments, the plurality of castellations 153 may comprise outward protrusions of material from the outer surface 152 of inner tubular 150.

In certain embodiments, the plurality of castellations 153 may comprise the same material makeup of inner tubular 150. In certain embodiments, the plurality of castellations 153 may comprise a series of ring shaped protrusions, each about a circumference of inner tubular 150. In certain embodiments, each of the ring shaped protrusions may comprise a flat or beveled outer edge.

In certain embodiments, plurality of castellations 153 may be disposed on inner tubular 150 in a uniform spacing. In other embodiments, the plurality of castellations 153 may be disposed on inner tubular in a non-uniform spacing. For example, in certain embodiments, the spacing of the plurality of castellations 153 may increase/and or decrease throughout a length of inner tubular 150. In certain embodiments, the each of the castellations 150 in the plurality of castellations 153 may have a spacing in the range of between 1 castellation a foot to 4 castellations a foot.

In certain embodiments, each castellation 153 may have a uniform length. In other embodiments, each castellation 153 may have a non-uniform length. For example, in certain embodiments, the lengths of the plurality of castellations 153 may increase/and or decrease throughout a length of inner tubular 150. In certain embodiments, each castellation 153 may have a length in the range of from 0.25 inches to 1 foot along an axial direction of inner tubular 150.

In certain embodiments, each castellation 153 may have a uniform height. In other embodiments, each castellation 153 may have a non-uniform height. For example, in certain embodiments, the heights of the plurality of castellations 153 may increase/and or decrease throughout a length of inner tubular 150. In certain embodiments, each castellation 153 may have a height in the range of from 0.25 inches to 3 inches.

In certain embodiments, outer tubular 160 may have the same material make up of inner tubular 150. In certain embodiments, outer tubular 160 may surround inner tubular 150. In certain embodiments, outer tubular 160 may be of a split tube construction, allowing outer tubular 160 to be longitudinally welded together around inner tubular 150. In certain embodiments, outer tubular 160 may be a solid tubular wall with no perforations, or no perforations other than access ports 166.

In certain embodiments, outer tubular 160 may have a length in the range of from 5 feet to 20 feet. In certain embodiments, outer tubular 160 may have a thickness in the range of from 1 inch to 2 inches. In certain embodiments, outer tubular 160 may be the same thickness of any marine riser that shock mitigation device 100 it is attached to. In certain embodiments, outer tubular 160 may be welded at a first end 164 to first end 130. In certain embodiments, outer tubular 160 may be welded at a second end 165 to second end 140.

In certain embodiments, outer tubular 160 and inner tubular 150 may define internal annulus 120.

In certain embodiments, outer tubular 160 may comprise an inner surface 161 and an outer surface 162. In certain embodiments, outer surface 162 may be a smooth surface. In certain embodiments, inner surface 161 may comprise a plurality of castellations 163. In certain embodiments, the plurality of castellations 163 may comprise inward protrusions of material from the inner surface 151 of outer tubular 160.

In certain embodiments, the plurality of castellations 163 may comprise the same material makeup of outer tubular 160. In certain embodiments, the plurality of castellations 163 may comprise a series of ring shaped protrusions, each about a circumference of outer tubular 160. In certain embodiments, each of the ring shaped protrusions may comprise a flat or beveled inner edge.

In certain embodiments, plurality of castellations 163 may be disposed on outer tubular 160 in a uniform spacing. In other embodiments, the plurality of castellations 163 may be disposed on outer tubular 160 in a non-uniform spacing. For example, in certain embodiments, the spacing of the plurality of castellations 163 may increase/and or decrease throughout a length of outer tubular 160. In certain embodiments, the each of the castellations 163 in the plurality of castellations 163 may have a spacing in the range of between 1 castellation a foot to 4 castellations a foot.

In certain embodiments, each castellation 163 may have a uniform length. In other embodiments, each castellation 163 may have a non-uniform length. For example, in certain embodiments, the lengths of the plurality of castellations 163 may increase/and or decrease throughout a length of outer tubular 160. In certain embodiments, each castellation 163 may have a length in the range of from 0.25 inches to 1 foot along an axial direction of outer tubular 160.

In certain embodiments, each castellation 163 may have a uniform height. In other embodiments, each castellation 163 may have a non-uniform height. For example, in certain embodiments, the heights of the plurality of castellations 163 may increase/and or decrease throughout a length of outer tubular 160. In certain embodiments, each castellation 163 may have a height in the range of from 0.25 inches to 3 inches.

In certain embodiments, each castellation 163 may be in line with each castellation 153. In other embodiments, each castellation 163 may be offset from each castellation 150. In certain embodiments, a portion of castellations 163 may be in line with a portion of castellations 153 and a portion of castellations 163 may be offset from a portion of castellations 153.

In certain embodiments, first end 130 and second end 140 may comprise 18.75 inches 15 M flanges. In certain embodiments, the 18.75 inches 15 M flanges may be studded. In certain embodiments, first end 130 may define an internal cavity 131. In certain embodiments, second end 140 may define an internal cavity 141. In certain embodiments, internal cavity 131, internal cavity 110, and internal cavity 141 may form a through bore through shock mitigation device 100.

In certain embodiments, internal annulus 120 of shock mitigation device 100 may be filled with a shock absorbing material. In certain embodiments, the shock absorbing material may comprise air, metallic foam, or sand. In certain embodiments, outer tubular 160 may comprise one or more access ports 166 to allow for internal annulus 120 to be filled or drained of the material.

In operation, shock mitigation device 100 may be capable of mitigating the effects of shock waves traveling up through shock mitigation device 100.

In certain embodiments, the plurality of castellations 153 allow for the mitigation of a shock wave traveling through a fluid disposed within inner cavity 110. In certain embodiments, the plurality of castellations 153 may permit inner tubular 150 to expand outward from force generated by a shockwave traveling through fluid disposed within internal cavity 110. In certain embodiments, this expansion may be permanent. In certain embodiments, the expansion may cause inner tubular to have a barrel shape.

In certain embodiments, the permanent expansion of the inner tubular 150 may slow the shockwave traveling through the fluid disposed within internal cavity 110. The expansion of inner tubular 150 may cause the fluid velocity of a shockwave to slow as it enters an expanded portion of inner tubular 150 and then further slow as it exits inner tubular 150.

In certain embodiments, for example when the internal annulus 120 is filled with air, the plurality of castellations 153 allow for the mitigation of a shock wave traveling through a fluid disposed within inner cavity 110. In certain embodiments, the plurality of castellations 153 may permit inner tubular 150 to expand outward from force generated by a shockwave traveling through fluid disposed within internal cavity 110. This expansion of the inner tubular 150 slows the shockwave traveling through the fluid disposed within internal cavity 110.

In certain embodiments, the plurality of castellations 163 and the plurality of castellations 153 may allow for the mitigation of a shock wave traveling through inner tubular 150 and outer tubular 160. When the shock wave travels through the cross-section of shock mitigation device 100 that comprise the plurality of castellations 163 and the plurality of castellations 153, the irregular path causes the shock wave to slow down. Furthermore, the deformation of inner tubular 150 may also cause an irregular path, thus causing the shock wave to slow down.

In certain embodiments, for example when internal annulus 120 is filled with a metallic foam, the plurality of castellations 153 allow for the mitigation of a shock wave traveling through a fluid disposed within inner cavity 110. While the presence of the metallic foam may limit the amount inner tubular 150 may expand outward from force generated by a shockwave traveling through fluid disposed within internal cavity 110, the expansion is still sufficient to slow the shockwave traveling through the fluid disposed within internal cavity 110.

In certain embodiments, the plurality of castellations 163 and the plurality of castellations 153 may allow for the mitigation of a shock wave traveling through inner tubular 150 and outer tubular 160. When the shock wave travels through the cross-section of shock mitigation device 100 that comprise the plurality of castellations 163 and the plurality of castellations 153, the irregular path causes the shock wave to slow down. Furthermore, the deformation of inner tubular 150 and the presence of the metallic foam may also cause an irregular path, thus causing the shock wave to slow down.

In certain embodiments, for example when internal annulus 120 is filled with sand and/or proppant, the plurality of castellations 153 allow for the mitigation of a shock wave traveling through the steel components of the mitigation device. While the presence of the sand/and or proppant may limit the amount inner tubular 150 may expand outward from force generated by a shockwave traveling through fluid disposed within internal cavity 110, the steel and sand/proppant combination is sufficient to slow the shockwave traveling through the steel disposed on either side of internal cavity 110.

In certain embodiments, the plurality of castellations 163 and the plurality of castellations 153 may allow for the mitigation of a shock wave traveling through inner tubular 150 and outer tubular 160. When the shock wave travels through the cross-section of shock mitigation device 100 that comprise the plurality of castellations 163 and the plurality of castellations 153, the irregular path and sand/proppant fill causes the shock wave to slow down. Furthermore, the deformation of inner tubular 150 and the presence of the sand and/or proppant may also cause an irregular path, thus causing the shock wave to slow down. Furthermore, the sand and/or proppant material may further mitigate the shock wave by transmitting it grain to grain in a radial direction, not axially.

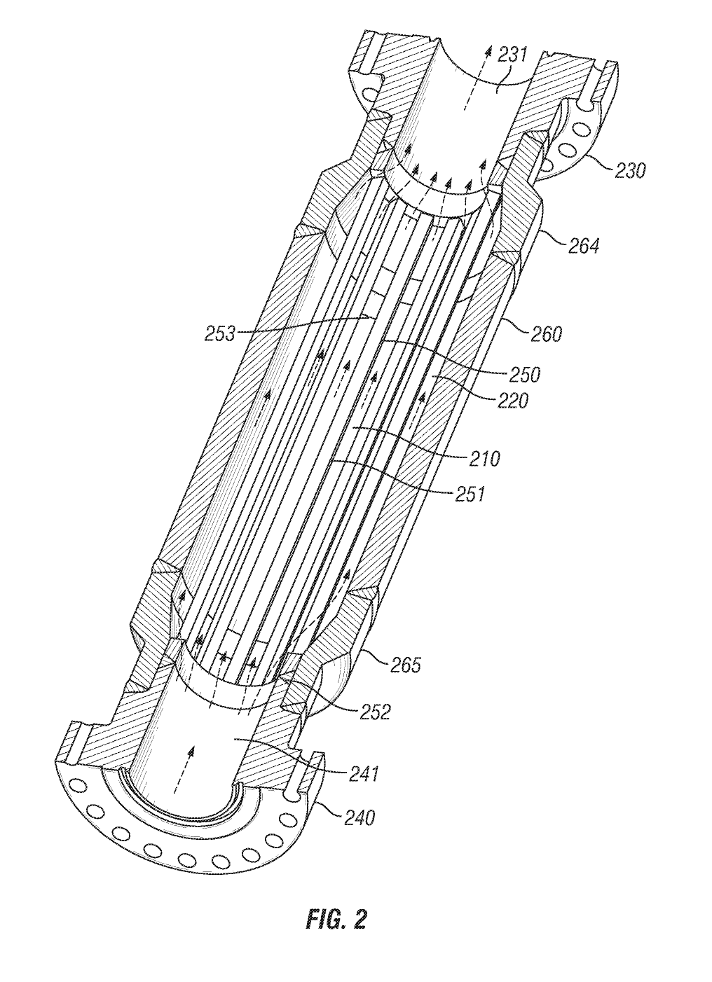

Referring now to FIG. 2, FIG. 2 illustrates a shock mitigation device 200. In certain embodiments, shock mitigation device 200 may comprise a joint of a riser or may be connected to one or more sections of a riser. In certain embodiments, shock mitigation device 200 may be a tubular device defining an internal cavity 210 and an internal annulus 220. In certain embodiments, shock mitigation device may be constructed out of any material that matches the pressure and load/structural capabilities of the equipment it is mated to.

In certain embodiments, shock mitigation device 200 may comprise a first end 230, a second end 240, an inner tubular 250, and an outer tubular 260.

In certain embodiments, inner tubular 250 may be a cradle structure comprising of a plurality of rods 251 and end pieces 252. In certain embodiments, inner tubular 250 may be constructed of low alloy carbon steel. In certain embodiments, inner tubular may comprise one, two, three, four, five, six, seven, eight, nine, or ten rods 251.

In certain embodiments, rods 251 may be square shaped rods. In certain embodiments, rods 251 may be have a square cross section with sides have lengths in the range of from 0.5 inches to 2.5 inches. In certain embodiments, end pieces 252 may be ring shaped structures.

In certain embodiments, each rod 251 may be connected to each end piece 252. In certain embodiments, the plurality of rods 251 may be arranged in an equispaced circular arrangement, thus defining internal cavity 210. In certain embodiments, gaps 253 between each rod may permit the flow of fluids to and from internal cavity but prevent tools from passing through. In certain embodiments, the gaps may be have a gap length in the range of from 0.5 inches to 3 inches. In certain embodiments, the gaps may be have a gap length in the range of from 1.5 inches to 3 inches. In certain embodiments, the gaps may be have a gap length in the range of from 2 inches to 3 inches.

In certain embodiments, inner tubular 250 may be welded at a first end piece 252 to first end 230. In certain embodiments, inner tubular 250 is not welded at a second end piece 252 to second end 240.

In certain embodiments, inner tubular 250 may have an inner diameter in the range of from 10 inches to 25 inches. In certain embodiments, inner tubular 250 may have an inner diameter of 18.75 inches. In certain embodiments, inner tubular 250 may define internal cavity 210.

In certain embodiments, outer tubular 260 may be a tubular wall constructed of any material that matches the pressure and load/structural capabilities of the equipment it is mated to. In certain embodiments, outer tubular 260 may surround inner tubular 250. In certain embodiments, outer tubular 260 may be a solid tubular wall with no perforations.

In certain embodiments, outer tubular 260 may have a length in the range of from 5 feet to 20 feet. In certain embodiments, outer tubular 260 may have a thickness in the range of from 1 inch to 3 inches. In certain embodiments, outer tubular 260 may have a thickness in the range of from 2 inches to 3 inches. In certain embodiments, outer tubular 260 may be welded at a first end 264 to first end 230. In certain embodiments, outer tubular 260 may be welded at a second end 265 to second end 240.

In certain embodiments, outer tubular 260 may have an outer diameter in the range of sizes to match the mating flanges of the blowout preventer stack it is to be mounted on. In certain embodiments, out tubular may have a uniform diameter. In other embodiments, outer tubular may have a taper at first end 264 and second end 265. In certain embodiments, the taper may have an angle in the range of from 30 degrees to 45 degrees. In certain embodiments, outer tubular 260 and inner tubular 250 may define internal annulus 220.

In certain embodiments, first end 230 and second end 240 may comprise 18.75 inches 15 M flanges. In certain embodiments, the 18.75 inches 15 M flanges may be studded. In certain embodiments, first end 230 may define an internal cavity 231. In certain embodiments, second end 240 may define an internal cavity 241. In certain embodiments, internal cavity 231, internal cavity 210, and internal cavity 241 may form a through bore through shock mitigation device 200. In certain embodiments, internal cavity 231, internal cavity 210, internal cavity 241, and annulus 220 may be in fluid communication with each other.

In operation, shock mitigation device 200 may be capable of mitigating the effects of shock waves traveling up through shock mitigation device 200.

In certain embodiments, gaps 253 in inner tubular 210 may permit a partial diversion of fluid traveling through internal cavity 210 into annulus 220. In certain embodiments, this diversion of fluid into annulus 220, which is restricted at least at the top end by an end piece, results in a reflection of the fluid shockwave, thus diminishing the pressure and velocity of the shockwave fluid. In addition, this partial diversion of fluid also slows the shockwave traveling through shock mitigation device 200.

In certain embodiments, the upper portion of inner tubular 250 may be not welded and free to move axially within outer tubular 260. This movement may allow the inner tubular 250 to absorb blast loads within the steel and transferring the shockwave circumferentially through the rods 251. Additionally, when the shock wave travels through the irregular path created by the inner tubular 250 and the outer tubular 260, the irregular path causes the shock wave to slow down.

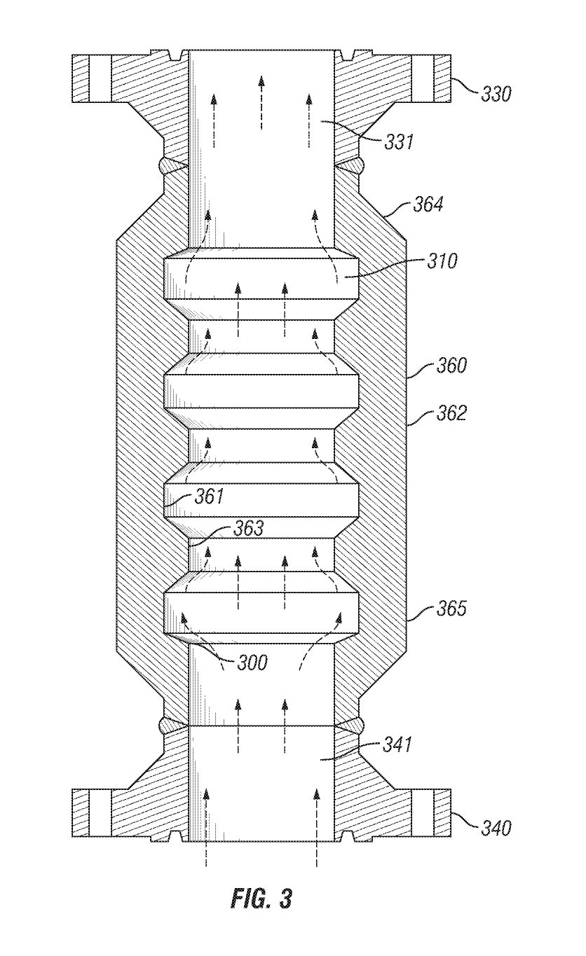

Referring now to FIG. 3, FIG. 3 illustrates a shock mitigation device 300. In certain embodiments, shock mitigation device 300 may comprise a joint of a riser or may be connected to one or more sections of a riser. In certain embodiments, shock mitigation device 300 may be a tubular device defining an internal cavity 310. In certain embodiments, shock mitigation device may be constructed out of any material that matches the pressure and load/structural capabilities of the equipment it is mated to.

In certain embodiments, shock mitigation device 300 may comprise a first end 330, a second end 340, and an inner tubular 360.

In certain embodiments, inner tubular 360 may be a tubular wall constructed of any material that matches the pressure and load/structural capabilities of the equipment it is mated to. In certain embodiments, inner tubular 360 may be a solid tubular wall.

In certain embodiments, inner tubular 360 may have a length in the range of form 5 feet to 20 feet. In certain embodiments, inner tubular 360 may have a thickness in the range of from 3 inches to 4 inches. In certain embodiments, inner tubular 360 may be welded at a first end 364 to first end 330. In certain embodiments, inner tubular 360 may be welded at a second end 365 to second end 340.

In certain embodiments, inner tubular 360 may have an outer diameter in the range of sizes to match the mating flanges of the blowout preventer stack it is to be mounted on. In certain embodiments, inner tubular 360 may define internal cavity 310.

In certain embodiments, inner tubular 360 may comprise and inner surface 361 and an outer surface 362. In certain embodiments, outer surface 362 may be a smooth surface. In certain embodiments, inner surface 361 may comprise a plurality of grooves 363. In certain embodiments, the plurality of grooves 363 may comprise a flat portion 364 and an angled portion 365.

In certain embodiments, the plurality of grooves 363 may comprise integral rings that go all the way around the tubular. In certain embodiments, the plurality of grooves 363. In certain embodiments, grooves 363 may comprise a 30 degree incline/decline allowing for a 26 inch increase of diameter for a 18¾″ through bore of the tool.

In certain embodiments, the particular angle selected for angled portion 365 may be selected to ensure that fluid is encouraged to pass into each groove while it is flowing through shock mitigation device 300 yet be shallow enough to ensure that any tools run through shock mitigation device 300 are not hung up or stuck during running in the hole or pulling out of the hole.

In certain embodiments, each groove 363 may be uniform in size. In certain embodiments, the plurality of grooves 363 may not be uniform in size. In certain embodiments, inner surface 361 may comprise 2 to 5 grooves 363 per foot.

In certain embodiments, first end 330 and second end 340 may comprise 18.75 inches 15 M flanges. In certain embodiments, the 18.75 inches 15 M flanges may be studded. In certain embodiments, first end 330 may define an internal cavity 331. In certain embodiments, second end 340 may define an internal cavity 341. In certain embodiments, internal cavity 331, internal cavity 310, and internal cavity 341 may form a through bore through shock mitigation device 300. In certain embodiments, internal cavity 331, internal cavity 310, and internal cavity 341 may be in fluid communication with each other.

In operation, shock mitigation device 300 may be capable of mitigating the effects of fluid shock waves traveling up through shock mitigation device 300.

In certain embodiments, the plurality of grooves 353 allow for the mitigation of a shock wave traveling through a fluid disposed within inner cavity 310. In certain embodiments, the plurality of grooves 353 allow the fluid shockwave to go into the grooves and then be returned back into the bore and then repeat that process at each groove. This creates a slowdown in the propagation of the shockwave up the fluid present in the inner cavity 310. The changes in steel cross-section due to the grooves may create an additional mitigation to the velocity of the shockwave traveling through the steel.

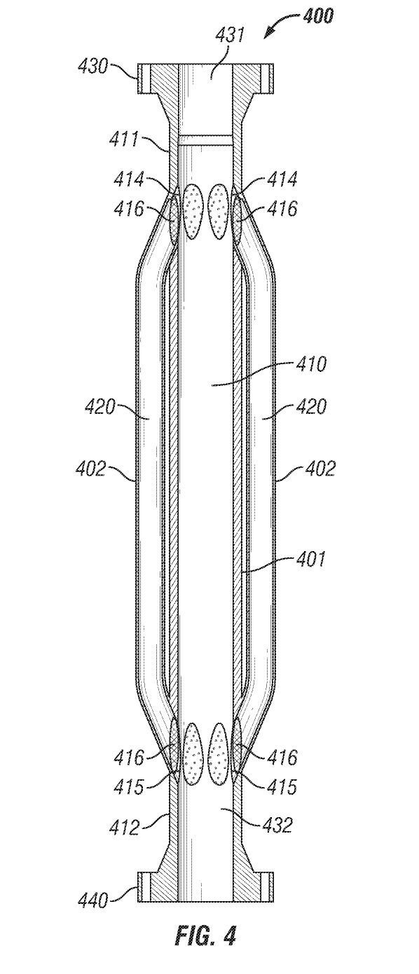

Referring now to FIG. 4, FIG. 4 illustrates a shock mitigation device 400. In certain embodiments, shock mitigation device 400 may comprise a joint of a riser or may be connected to one or more sections of a riser. In certain embodiments, shock mitigation device 400 may be a tubular device comprising an inner tubular 401 defining an internal cavity 410 and one or more outer tubulars 402 defining by pass cavities 420. In certain embodiments, shock mitigation device 400 may comprise a first end 430 and a second end 440. In certain embodiments, shock mitigation device 400 may be constructed out of any material that matches the pressure and load/structural capabilities of the equipment it is mated to.

In certain embodiments, inner tubular 401 may be a tubular wall constructed of any material that matches the pressure and load/structural capabilities of the equipment it is mated to. In certain embodiments, inner tubular 401 may have a length in the range of from 5 feet to 20 feet. In certain embodiments, inner tubular 401 may have a thickness in the range of from 3 inches to 4 inches. In certain embodiments, inner tubular 401 may be welded at a first end 411 to first end 430. In certain embodiments, inner tubular 401 may be welded at a second end 412 to second end 340.

In certain embodiments, inner tubular 401 may have an outer diameter in the range of sizes to match the mating flanges of the blowout preventer stack it is to be mounted on.

In certain embodiments, inner tubular 401 may further comprise one or more inlet ports 414 at first end 411 and one or more outlet ports 415 at second end 412. In certain embodiments, each of the one or more inlets ports 415 and outlet ports 415 may be covered by a screen plate 416. In certain embodiments, the one or more inlet ports may allow fluid to travel from inner tubular 401 into the one or more outer tubulars 402.

In certain embodiments, shock mitigation device 400 may comprise one, two, three, four, five, six, seven, or eight by outer tubulars 402. In certain embodiments, the one or more outer tubulars 402 may be disposed around a circumference of inner tubular 401. In certain embodiments, each outer tubular 402 may be connected to inner tubular 401 by a separate inlet port 414 and a separate outlet port 415.

In certain embodiments, each of the one or more outer tubulars 402 may have an inner diameter in the range of from 5 inches to 10 inches. In certain embodiments, each of the one or more outer tubulars 402 may have an inner diameter in the range of from 7 to 9 inches. In certain embodiments, the one or more outer tubulars 402 may have a length in the range of from 5 feet to 20 feet.

In certain embodiments, first end 430 and second end 440 may comprise 18.75 inches 15 M flanges. In certain embodiments, the 18.75 inches 15 M flanges may be studded. In certain embodiments, first end 430 may define an internal cavity 431. In certain embodiments, second end 440 may define an internal cavity 441. In certain embodiments, internal cavity 431, internal cavity 410, and internal cavity 441 may form a through bore through shock mitigation device 400. In certain embodiments, internal cavity 431, internal cavity 410, by pass cavity 420, and internal cavity 341 may be in fluid communication with each other.

In operation, shock mitigation device 400 may be capable of mitigating the effects of fluid shock waves traveling up through shock mitigation device 400. In certain embodiments, the outer tubulars 402 enable a larger flow area than the flow area provided by the inner tubular 401 and that increase flow area may significantly slow down the shockwave velocity in the fluid. In addition, the change in metal component cross-sections in the device/tool may materially affect the shockwave speed in the metal reducing it to safe levels.

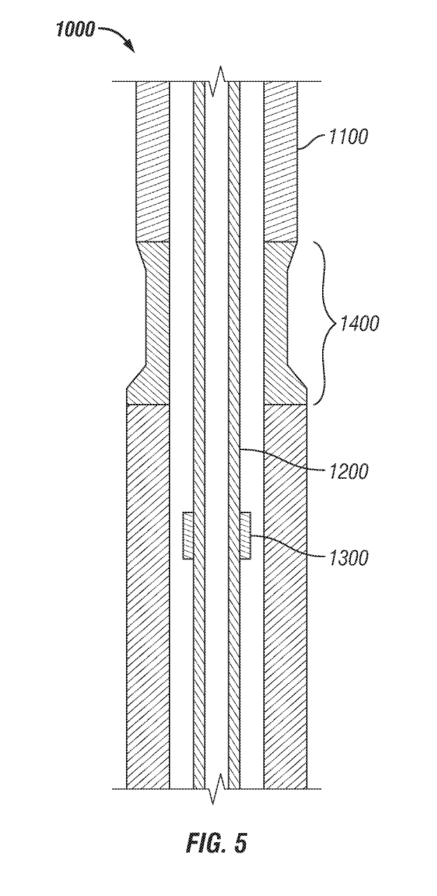

Referring now to FIG. 5, FIG. 5 illustrates a shock mitigation system 1000. In certain embodiments, shock mitigation system 1000 may comprise tubular 1100, work string 1200, emergency separation tool 1300, and shock mitigation device 1400.

In certain embodiments, tubular 1100 may comprise a marine riser above a blowout preventer stack. In certain embodiments, tubular 1100 may comprise any conventional type of riser.

In certain embodiments, workstring 1200 may be disposed within an annulus of tubular 1100. In certain embodiments, workstring 1200 may comprise a drilling string, a production string, or a casing. In certain embodiments, a portion of workstring 1200 may comprise a heavyweight non-shearable drill collar.

In certain embodiments, emergency separation tool 1300 may be disposed around a portion of workstring 1200. In certain embodiments, the portion of work string 1200 surrounded by separation tool 1300 may be the drill collar.

In certain embodiments, emergency separation tool 1300 may comprise and conventional type of separation tool. Examples of conventional separation tools are described in U.S. Pat. Nos. 5,253,585, 7,779,760, 5,251,702, and 9,097,080 and U.S. Patent Application Publication Nos. 2013/0220631, 2013/0214183, and 2014/0224500, the entireties of which are hereby incorporated by reference. In certain embodiments, emergency separation tool 1300 may be disposed around tubular 1100.

In certain embodiments, shock mitigation device 1400 may be placed below emergency separation tool 1300 and/or above emergency separation tool 1300. In certain embodiments, as shown in FIG. 5, shock mitigation device 1400 may be placed above emergency separation tool 1300. In certain embodiments, shock mitigation device 1400 may make up a portion of tubular 1100. In other embodiments, shock mitigation device 1400 may connect a first portion 1101 of tubular 1100 to a second portion 1102 of tubular 1000.

In certain embodiments, shock mitigation device 1400 may comprise any combination of features discussed above with respect to shock mitigation devices 100, 200, 300, and/or 400.

In certain embodiments, the present disclosure provides a method comprising: providing a shock mitigation system, wherein the shock mitigation system comprises a riser, a drill pipe disposed within the riser, an emergency separation tool disposed around the drill pipe, and a shock mitigation device attached to the riser, wherein the shock mitigation device comprises a first end, a second end, an inner tubular, and an outer tubular, wherein the inner tubular defines an internal cavity and wherein the inner tubular and the outer tubular define an internal annulus and severing the drill pipe with the emergency separation tool.

In certain embodiments, the shock mitigation system may comprise any combination of features discussed above with respect to shock mitigation system 1000. In certain embodiments, the riser may comprise any combination of features discussed above with respect to tubular 1100. In certain embodiments, the drill pipe may comprise any combination of features discussed above with respect to work string 1200. In certain embodiments, the emergency separation tool may comprise any combination of features discussed above with respect to emergency separation tool 1300. In certain embodiments, the shock mitigation device 1400 may comprise any combination of features discussed above with respect to shocking mitigating device 1400, 100, 200, 300, and/or 400.

In certain embodiments, the method may further comprise severing the drill pipe with the emergency separation tool. In certain embodiments, the act of severing the drill pipe may cause a shock wave to propagate up through the drill pipe and/or any fluid disposed within the drill pipe. In certain embodiments, the method may further comprise allowing the shock mitigation device to mitigate the effects of the shock wave. In certain embodiments, the method may further comprise allowing the shock mitigation device to slow down the shock wave.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. A shock mitigation device comprising: a first end, a second end, and an inner tubular, wherein the inner tubular defines an internal cavity.

2. The shock mitigation device of claim 1, further comprising an outer tubular, wherein the inner tubular and the outer tubular define an internal annulus.

3. The shock mitigation device of claim 2, wherein the inner tubular comprises an outer surface comprising a plurality of castellations and the outer tubular comprises an inner surface comprising a plurality of castellations.

4. The shock mitigation device of claim 2, wherein the internal annulus is filled with a shock absorbing material.

5. The shock mitigation device of claim 1, wherein the inner tubular comprises a cradle structure comprising a plurality of rods and end pieces.

6. The shock mitigation device of claim 5, wherein the cradle structure comprises a plurality of gaps between the plurality of rods.

7. The shock mitigation device of claim 1, wherein the inner tubular comprises an inner surface comprising a plurality of grooves.

8. The shock mitigation device of claim 7, wherein each groove comprises a flat portion and an angled portion.

9. The shock mitigation device of claim 1, further comprising one or more outer tubulars, wherein the one or more outer tubulars define one or more by pass cavities.

10. The shock mitigation device of claim 9, wherein the one or more outer tubulars are attached to the inner tubular at one or more inlet ports and one or more outlet ports.
